(19) United States
(12) Patent Application Publication
(10) Pub. No.: US 2004/0249735 A1
(43) Pub. Date: Dec. 9, 2004

(54) Charitable investment fund

(76) Inventors: Michael Joseph Cassani, Cincinnati, OH (US); Gregory Allen Harris, Loveland, OH (US)

Correspondence Address: HASSE GUTTAG & NESBITT LLC, 7550 CENTRAL PARK BLVD., MASON, OH, 45040, US

(21) Appl. No.: 10/626,236

(22) Filed: Jul. 24, 2003

Related U.S. Application Data
(63) Continuation-in-part of application No. 10/371,103, filed on Feb. 21, 2003.
(60) Provisional application No. 60/364,310, filed on Mar. 14, 2002.

(51) Int. Cl. G06F 17/60

(52) U.S. Cl. 705/35

(57) ABSTRACT

An investment fund in which a portion of the assessed investment fund fees and/or investment fund service providers' fees are designated for donation to charitable causes as directed by each of the investment fund's shareholders. Shareholders of one or more charitable share classes designate one or more charities to receive the accumulated donation amounts attributable to their individual accounts. Donation amounts are then tracked and paid to charities on a periodic basis according to the designations on the records of the investment fund.

### REFERENCE TO RELATED PROVISION APPLICATION

This application is a continuation-in-part of U.S. application Ser. No. 10/371,103 filed Feb. 21, 2003 which claims benefit under §119(e) of the U.S. Patent Act (35 U.S.C. 119(e)) to U.S. Provisional Application No. 60/364,310 filed Mar. 14, 2002.

### FIELD OF INVENTION

This invention relates generally to the field of financial advisory systems, and more specifically, to systems and processes for operating and managing an investment fund in which charitable donations by the fund and/or its service providers are directed by the fund shareholders.

### BACKGROUND OF THE INVENTION

In modern society, many individuals invest money in financial markets for retirement savings, financial gain and to achieve other financial goals. A common financial vehicle for investment is an investment fund, such as a mutual fund, in which large groups of individuals pool their money for collective investment by a central administration. The mutual fund accomplishes the goal of reducing investment risk by diversifying the investments of the group by spreading the risk among a greater number and types of investments than an individual could conveniently do by himself or herself. Also, the central administration provides professional investment and money management experience to the group. The individual investors are assessed fees in connection with the operation of the mutual fund, typically calculated as a percentage of the assets during a given period of time and/or transaction fees on the sale or purchases of investments. The fund itself also pays a variety of fees to third party service providers.

Types of investment funds include investment companies, common trust and collective trust funds, and hedge funds. Investment companies are comprised of four main types of investment vehicles: mutual funds, closed-end funds, unit investment trusts, and exchange-traded funds. A closed-end fund is a type of investment company that has a fixed number of shares that are publicly traded. The price of the shares of a closed-end fund fluctuates based on investor supply and demand. Closed-end funds are not required to redeem shares and have managed portfolios. A unit investment trust (UIT) is an investment company that buys and holds a fixed number of shares until the trust's termination date. When the trust is dissolved, proceeds are paid to shareholders. A UIT has an unmanaged portfolio. Like a mutual fund, shares of a UIT can be redeemed on any business day. An exchange-traded fund (ETF) is an investment company with shares that trade intraday on stock exchanges at market-determined prices. Investors may buy or sell ETF shares through a broker just as they would the shares of any publicly traded company. Common trust and collective trust funds are asset pools for the collective investment of assets held in a fiduciary or ERISA capacity by a trust company or bank. Common trust and collective trust fund units may only be purchased or redeemed through the trust company or bank. A hedge fund is a private investment pool for wealthy investors that, unlike a mutual fund, is exempt from SEC regulation.

Some of these investment funds, specifically mutual funds, can have multiple classes of shares. Such share classes are typically distinguished by varying expense ratios that reflect the differing costs of providing services to the holders of each particular share class while permitting holders to enjoy economies of scale. Although the costs differ between the various share classes, the underlying investments are identical for all share classes.

Among other reasons, individuals often invest to increase their financial resources available for giving to charities and charitable causes. A number of types of investment funds have been devised to assist individuals in giving to charitable causes, such as socially responsible funds, organization sponsored funds and donor advised charitable funds.

Socially responsible funds are mutual funds that promote socially responsible investing or an investment strategy that requires adherence to a set of faith based standards. According to the Social Investment Forum, as of 1999, socially responsible investing (all investment product types) reached the $2 trillion mark with approximately 12.5% of all assets under professional management. Growth of assets involved in socially responsible investments grew at twice the rate (82%) of all assets under professional management between 1997 and 1999. While socially responsible funds permit investment in accordance with an individual investor's principles, they do not directly benefit the charitable causes that interest the investor unless the investor independently elects to sell a portion of his investment and donate it to an individual charity.

Organization sponsored funds are mutual funds that promote socially responsible investing or an investment strategy that requires adherence to a set of faith based standards (some funds are active proponents for change) that are backed and promoted by a particular religious based organization. Any service fees resulting in profits for the mutual funds are absorbed by that organization. This permits individual investors to invest according to their principles and benefit a charitable organization of their choosing, but it limits such charitable benefits to large organizations that are capable of managing mutual funds. Also, the managing organization receives the entire benefit and any other charitable causes to which the investor wishes to contribute must be made directly by the investors by selling a portion of his investment. Further, such organizations may not have the management expertise the investor desires and the decision to invest on certain social principles may hinder the return of the mutual fund, and accordingly, the individual investor's investment.

Donor advised charitable funds are philanthropic vehicles that allow individuals who do not want to or cannot afford to set up their own foundations a cost-effective method of donating to charitable causes. These funds provide a simplified format for giving to multiple charities through a single account, summarized in regular statements. Contributions to a charitable fund are invested in one of several portfolios tailored to particular investment goals (e.g. growth, equity income, interest income and money-market pools, etc.) which are offered by the investment management company, and thus can grow before it is passed on to its ultimate charitable recipients. Donor-advised funds, as well as private foundations, allow the investor/donor to claim a tax deduction immediately, and then distribute the money from the charitable fund over a number of years. Therefore, the donation can be timed for maximum tax advantage. Since the fund is organized as a charity, the investment serves as a contribution and is deductible. The principal drawback of this arrangement is that it is irrevocable. Correspondingly, it requires donation of the entire investment.

Other charitable financial vehicles exist, but they tend to be expensive and time consuming, require setting aside entire investments for charitable purposes, fail to produce an ongoing revenue stream and/or do not produce any personal return for the investor.

Thus a need exists for an investment vehicle that permits individual investors who cannot afford to or choose not to relinquish control of their assets to minimize their investment risk and pursue high rates of return while contributing ongoing income streams to the charitable funds of interest to an individual investor.

### SUMMARY OF THE INVENTION

The present invention is an investment fund in which a portion of the assessed fund fees and/or vendor service fees are set aside by the fund's administrator for donation to charitable causes as directed by each of the individual shareholders. Shareholders designate one or more charities to receive the accumulated donation amounts that result from their proportionate investment in the investment fund. Donation amounts are tracked and paid to charities on a periodic basis according to shareholder and charity records held on the investment fund's transfer agent system.

The charities and shareholders each receive reports regarding the fund donations. Each charity designated receives a statement along with the periodic payment that identifies the amounts donated and a list of the corresponding shareholders, although shareholders have the ability to remain anonymous if desired. Each shareholder receives a summary of their portion of the investment fund's donation on their periodic statement. The portion of the investment fund manager's fees or other service providers' fees to be donated to charities, may be disclosed as a separate line item in the investment fund's prospectus expense table.

Because it is expensive and complex to set up new investment funds, the invention can also be used in connection with existing funds by establishing a specific class of shares in a fund for calculating and distributing donations for charitable purposes. The designated charitable share class would be distinguished from the other share classes by having a donation portion of the expense ratio.

The present invention has many advantages for investors, sponsors and charities. One advantage is that donations are calculated and paid directly to the investor's charity of choice via an automated periodic distribution process, allowing investors to support their charities in ways not available before. Another advantage is that multiple charities may be elected and benefited by an individual investor with a single investment vehicle. Another advantage is that it enables investors to pursue industry competitive returns on their invested assets while obtaining charitable benefits from their investment. Another advantage is that shareholders have flexibility and control of their investments since they may purchase or redeem shares of the investment fund on any business day. Another advantage is that investors in 401(k) and IRA accounts may utilize their assets via an investment in the investment fund to benefit the charity of their choice, whereas previously these retirement vehicles have not been available to benefit charities.

One advantage of the present invention for sponsors (e.g. fund investment advisors and service providers) is that the sponsors and affiliated departments and brokers are able to attract a new market segment, thereby increasing assets under management and generating new reoccurring revenues and sales commissions. Another advantage of the invention is that it encourages investors to increase their investment in the funds to increase their charitable donations. Another advantage is that the invention provides a strong retention incentive to investors, thereby reducing investor turnover and aiding in the growth of managed assets. Another advantage is that the sponsors will benefit from the tax benefits of making deductible donations. Another advantage is that the invention creates positive publicity for the sponsors and will enable the sponsors to obtain charity support for the use of the funds. The principal advantages of the invention for charities are a new source for reoccurring revenue streams and the availability of an investment vehicle that a charity can recommend to its supporters for support without the drawbacks described herein.

### BRIEF DESCRIPTION OF THE DRAWINGS

FIG. 1 is a block diagram of the selection of the investment format.

FIG. 2 is a block diagram of the initial acquisition of the open-ended mutual fund shares.

FIG. 3 is a block diagram of the establishment of the mutual fund donation expenses.

FIG. 4 is a block diagram of the process for formation of a new class of charitable shares.

FIG. 5 is a block diagram of the mutual fund account application process.

FIG. 6 is a block diagram of the daily operation of the mutual fund operation and donation process.

FIG. 7 is a block diagram of the periodic donation expense distribution process of the mutual fund.

### DETAILED DESCRIPTION OF THE DRAWINGS

This invention relates to an investment fund in which a portion of the assessed mutual fund fees and/or vendor expenses are donated to charitable causes designated by the individual fund shareholders. The most widespread form of investment fund in existence that is compatible with this concept is an open-ended mutual fund.

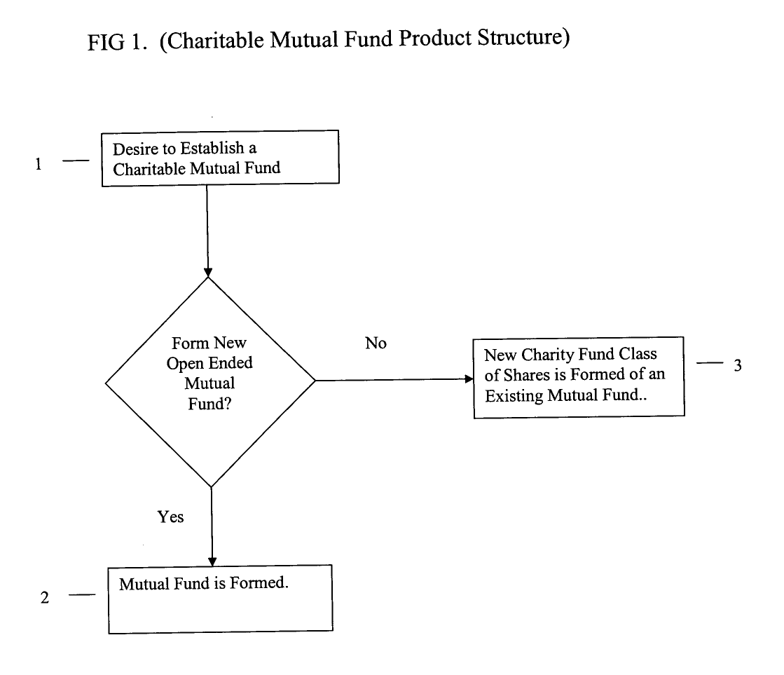

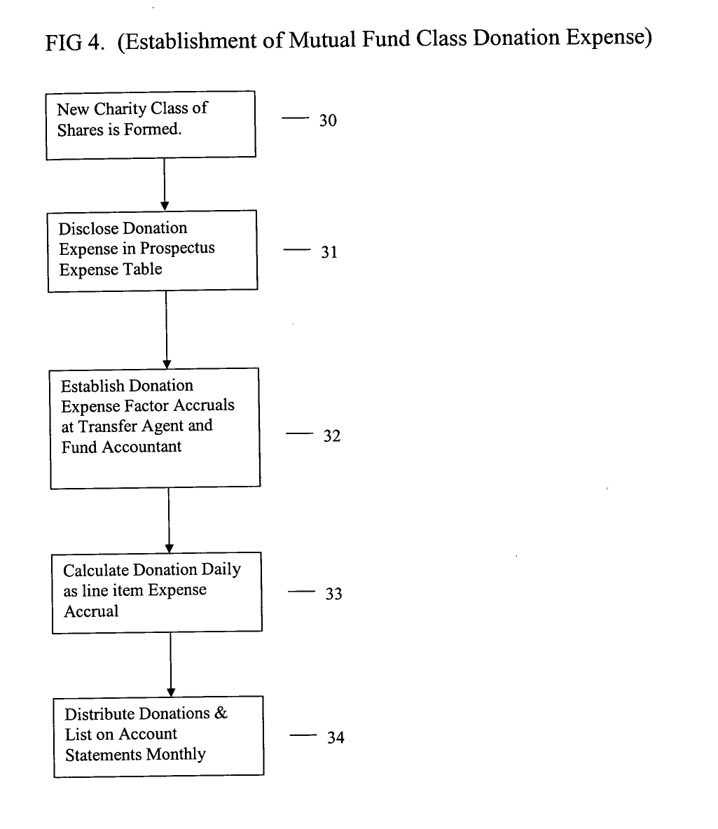

FIG. 1 shows the selection between forming a new mutual fund 1 and forming a new class of charitable shares 3. If the fund that desires to provide the charitable aspects of the invention already exists, then the fund will simply create a new class of shares as further depicted in FIG. 4. If the fund has not yet been formed, then the new fund 1 will be established. Even in the event that a new fund is established, the fund 1 may still have multiple classes of shares including share classes that are not charitable.

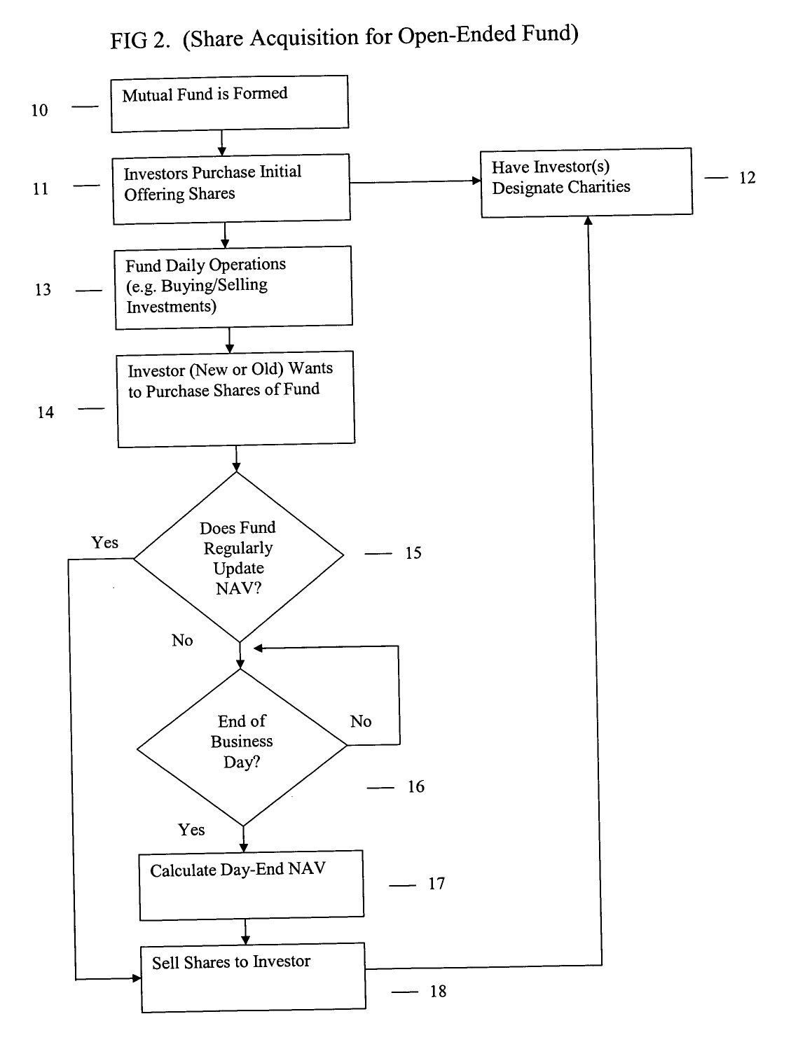

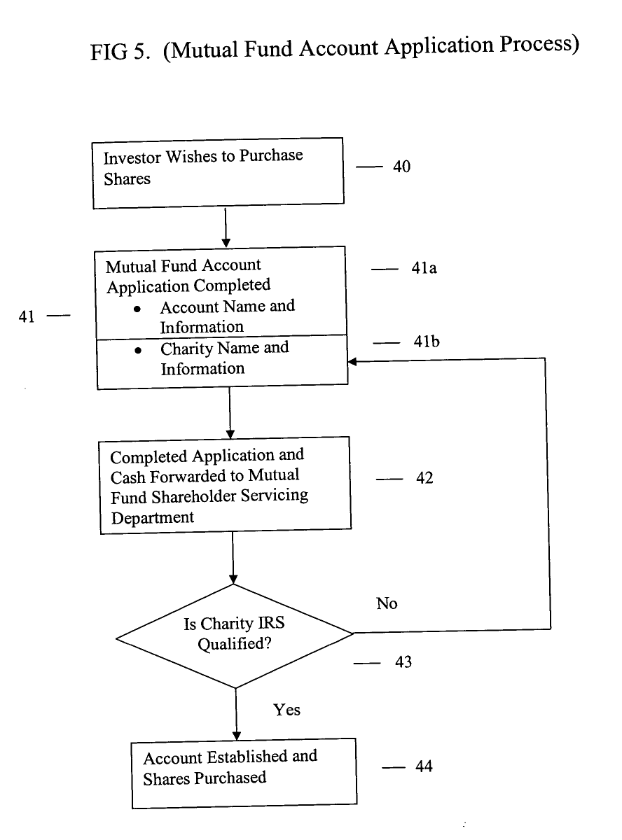

In an open-ended mutual fund, as depicted in FIG. 2, the fund 1 commences operations by offering shares to third party shareholders through an initial public offering at 2. Shareholders may be given the option to purchase shares directly from the mutual fund or through broker agents. After the initial sale and designation of charities in the manner described in connection with FIG. 5, the fund commences its daily operations of buying and selling investment properties on behalf of the investor pool at 4 by using the proceeds of the initial sale of shares as well as any subsequent share sales. As an open-ended mutual fund, the fund 1 may sell shares to the public, either directly or through broker agents, after the initial issuance of shares. This contrasts with closed-end funds, in which no additional shares may be sold and the fund is limited to the initial capital raised by the initial sale of shares. Accordingly, when a new or existing investor desires to buy shares at 5, or an existing shareholder desires to sell shares, the transaction occurs, directly or indirectly, through sale or redemption of shares by the fund 1. The fund 1 is required under law to sell the shares at the Net Asset Value (NAV) of the shares at the time of sale. Because this is a complicated calculation, most funds calculate the NAV once per day after the close of traditional equity markets and conduct sales and redemptions based on that price; however, some funds do calculate the NAV on an ongoing basis (e.g. hourly) as at 6. If the NAV is calculated on an ongoing basis as at 6, the fund 1 can sell shares to the investor as at 9. If the NAV is calculated at the end of the business day then the fund 1 must wait until the end of the business day as in 7 to calculate the NAV at 8 before it can sell shares to the investor as at 9.

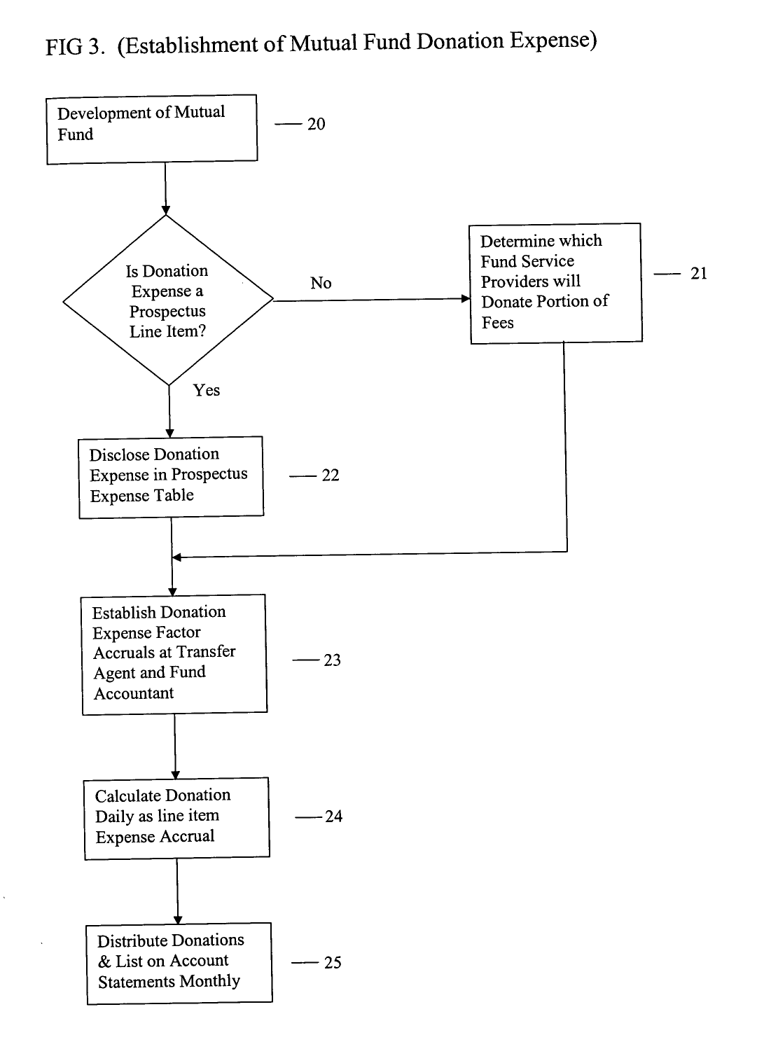

The establishment of the donation expense is depicted in FIG. 3. As the specific financial characteristics of the fund are defined and the fund is developed as at 10, as described in FIG. 2, the mutual fund must determine whether the donation expense is to be a line item expense of the mutual fund or to be a donation paid by the mutual fund service providers at 11. If the donation expense is a line item of the fund it must be disclosed in the fund's prospectus expense table 12. After the determination of the source of the donation expense, the donation expense factor accruals are established with the transfer agent and fund accountants at 13 to permit tracking of the accrued donation expense amounts. The fund accountant then calculates on a daily basis the donation expense accrual at 14 either as a fund expense or as a portion of the expenses paid to participating service providers. At the time designated by the fund, preferably at the end of the month, the fund will distribute the accrued donation expenses and list such donations on the periodic account statements of its shareholders at 15.

The establishment of a new class of charitable shares in a mutual fund is disclosed in FIG. 4. The new class of shares is formed at 30 by satisfying the legal procedures and requirements. The donation expense is disclosed in the prospectus expense table at 31 and the donation expense factor accruals are established with the transfer agent and fund accountant at 32. The donation would then typically be calculated on daily basis as a line item expense accrual as shown in 33 and then distributed to the designated charities and listed on the account statements of the fund holders.

Application for investment in the fund and the designation of charities is depicted in FIG. 5. To purchase shares at 20, investors are required to complete a fund account application form at 22. The application form is used to obtain account name and information at 22a and the charity designation information at 22b. The application form and monies for the investment are then forwarded to the shareholder servicing department of the mutual fund at 23 for processing and approval or rejection. If the investor is approved, the fund then reviews the charitable designations of the shareholder. If the charitable designations are acceptable to the fund, the account is established and the shares are purchased at 24. If the charitable designations are unacceptable to the fund, the shareholder will be requested to amend or change his or her designations at 22b. Within legal limits, the fund can create charitable fund qualifications and limits. Preferably, the fund will limit charities that may be designated to charities qualified by the U.S. Internal Revenue Service at 25, such as 501(c)(3) organizations, to gain certain tax advantages for itself and/or its shareholders and to reduce administrative oversight relating to the validity of the charity. Further, the fund will preferably limit the number of charities that may be designated by a shareholder to reduce the administrative effort relating to the charitable disbursements and avoid the potential for dilution of donations caused by designation of a large number of charities by a shareholder.

Whether a third party agent is used to purchase and hold the shares will affect the manner in which the designations are obtained. If the agent holds the shares in its street name, the agent will need to provide the charitable designations for the purchased shares on behalf of the investor. Agents also treat their clients' mutual fund investments in different ways. Some agents pool clients' investments as an omnibus investment combined into a single account with the fund. With an omnibus investment structure, the agent would need to provide initial and updated designations to the fund administration as a single block, thereby placing administrative demands for tracking the designations on the agent. Other agents administrate client investments on a network level in which each client investment is mirrored with a separate account between the agent and the fund. With network level investments, the designations would be made for the individual mirrored accounts in a manner similar to those held directly by individual shareholders.

Designation of the charities may be changed from time-to-time by the shareholder by notifying the fund of the changes. In the preferred embodiment, the shareholder will be limited to changing his or her designation after the end of the then current donation period to simplify administration of the apportionment and payment of the charitable donations. The frequency of changing charitable designations may also be limited by the capabilities of the transfer agent.

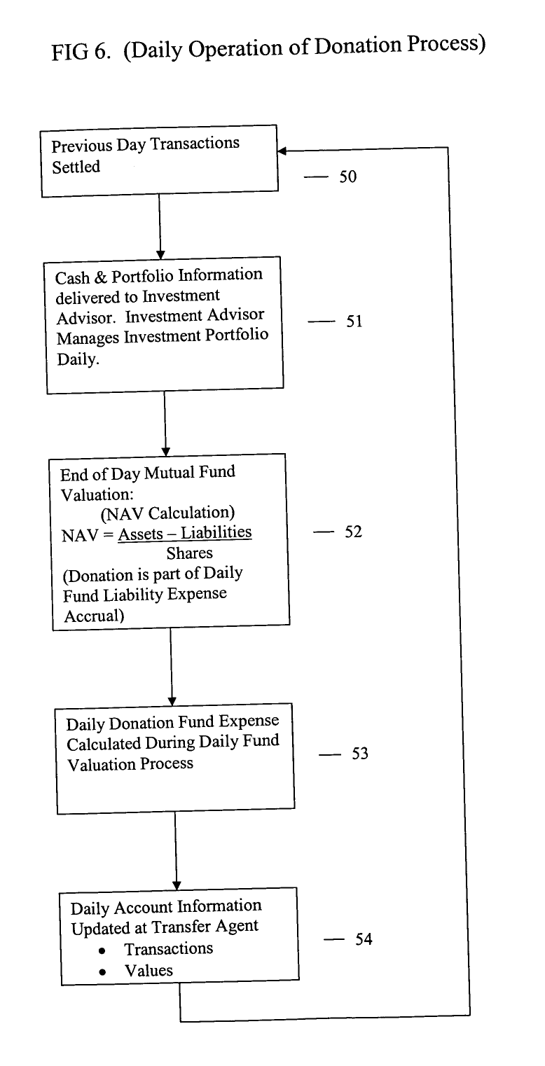

The daily administration of the fund donation process is depicted in FIG. 6. At some point after the completion of a business day, but prior to the commencement of the subsequent business day, the transactions from the last business day are settled at 30. Thereafter the cash and portfolio information is delivered to the investment advisor at 31 who is responsible for the daily management of the fund portfolio. The NAV, as described above, is calculated by subtracting the fund's liabilities from its assets and dividing that by the number of outstanding shares at 32. The donation expense is calculated as part of the daily fund valuation process at 33. The daily donation expense can then be recorded as a single joint amount for the entire fund or the fund can apportion the daily donation amount and update the daily account information for its shareholders along with providing the shareholders with a transaction record and fund values at 34.

Tracking and payment of the donation expense can be performed in several ways. One method is to add the single daily joint donation expense amounts together and then multiply that amount by the accumulated proportionate charitable designations in effect during the designated distribution period. Another method is to calculate the donation expense amount on a daily basis, record the proportionate amounts to the individual shareholder accounts on a daily basis and then add the individual account amounts at the end of the designated period for each charitable organization. The exact manner of calculating the charitable amounts can easily be modified for administrative convenience and a number of possibilities will work equally well for administrating the current invention.

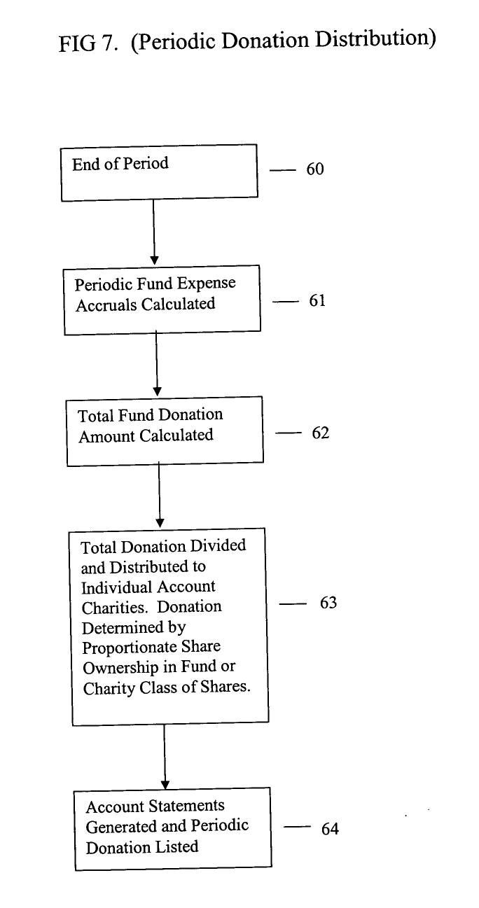

The periodic donation distribution is depicted in FIG. 7. At the end of the period at 40, preferably at the end of the month, the periodic fund expense accrual is calculated at 41 and the total fund donation amount is calculated at 42. The total donation amount is then apportioned and distributed to the charities designated by the fund shareholders in proportion to the shareholder ownership in the fund. at 43. The payment of the proportionate donation amount is noted on the fund shareholders' individual account statements at 44. The statement clearly notes that the donation amount is paid from the fund expenses as described in FIG. 2 hereof and not deducted from the shareholder's account. The fund may also establish a minimum level for charitable donation distribution to avoid making distributions during a particular designated period if the distribution does not meet a certain dollar figure. In such event, the fund would retain the payments until the accumulated distribution amounts were greater than the designated dollar amount at the end of a designated period.

The preceding description of the invention has shown and described certain embodiments thereof; however, it is intended by way of illustration and example only and not by way of limitation. Those skilled in the art should understand that various changes, omissions and additions may be made to the invention without departing from the spirit and scope of the invention.

We claim:

1. A method of operating a financial investment fund having a plurality of securities for charitable purposes, the method comprising:
creating one or more charitable share classes of said securities;
designating a contribution amount for distribution to charities or charitable causes for said one or more charitable share classes;
having the holders of said one or more charitable share classes designate charities to receive said designated contribution amounts;
accumulating said contribution amounts for a designated period of time; and
distributing said accumulated contribution amounts to said designated charities.

2. The method of claim 1 wherein said fund is a mutual fund.

3. The method of claim 2 wherein said one or more charitable share classes are issued by a pre-existing open-end fund.

4. The method of claim 2 wherein said one or more charitable share classes are issued by a pre-existing closed-end fund.

5. The method of claim 1 wherein said securities are publicly listed and traded.

6. The method of claim 1 wherein said fund has an investment objective of investing based upon socially responsible criteria.

7. The method of claim 1 wherein said fund is actively managed by an investment advisor.

8. The method of claim 1 wherein said designated period of time is one month and said distributing step is performed on a monthly basis.

9. The method of claim 1 wherein said contribution amounts are withheld as a line item expense of said fund.

10. The method of claim 1 wherein there are a plurality of said holders of said one or more charitable share classes and the account data for said charitable share classes of said fund includes an account for each holder.

11. The method of claim 10 wherein said account information includes reports generated for said holders and said designated charities detailing the contribution amounts, dates of contributions and other information pertaining to said contribution amounts.

12. The method according to claim 1, wherein the distributing step includes distributing said contribution amounts to said designated entities only after said contribution amounts for all of said holders designating said designated entity are above a predetermined minimum amount.

13. The method of claim 1 wherein said contribution amounts are designated as percentage values of the investment of said holder or the expenses of said fund.

14. The method of claim 13 wherein the account data of said fund includes a separate account for each of said charities in which said individual fund designations of said holders are cumulated and said contribution amounts from said holders are calculated cumulatively.

15. The method of claim 1 wherein said fund is a common or collective fund.

16. In a financial investment fund for charitable purposes having one or more charitable share classes that has: (i) a contribution amount designated for distribution to charities or charitable causes, (ii) holders of said one or more charitable share classes designate charities to receive said designated contribution amounts; (iii) said contribution amounts accumulated for a designated period of time; and (iv) said accumulated contribution amounts distributed to said designated charities, a method for starting up said fund comprising:
issuing one or more charitable share classes to be bought from and redeemed with said fund at a net asset value;
selling and redeeming said charitable share classes to said holders;
obtaining designations of charities from said holders;
maintaining account data for the outstanding charitable share classes in one or more computers.

17. The method of claim 16, wherein said obtaining step further comprises requiring selection of said charities from a list of charities designated by said fund.

18. The method of claim 16, wherein said issuing step further comprises issuing one or more charitable share classes that are listed for trading on a securities exchange and that are bought and sold at negotiated market prices and wherein said method further comprises:
having a secondary market holder purchase or sell one or more of said one or more charitable share classes on the secondary market through a broker; and
updating said account data for said secondary market holder on said one or more computers.

19. The method of claim 18, wherein said obtaining step further comprises requiring selection of said charities from a list of charities designated by said fund.

20. A method for recordkeeping for a fund with charitable purposes having one or more charitable share classes that has: (i) a contribution amount designated for distribution to charities or charitable causes, (ii) holders of said one or more charitable share classes designate charities to receive said designated contribution amounts; (iii) said contribution amounts accumulated for a designated period of time; and (iv) said accumulated contribution amounts distributed to said designated charities, the method comprising:
storing in a computer system information relating to said fund;
accepting investor capital from at least one holder;
storing information in the computer system relating to said at least one holder, wherein the stored information includes investor identification information, investment amounts, the terms of investments and the charitable designations of said holder; and
storing information in the computer system relating to said fund, wherein said stored information includes the investments and investment history of said fund and the contribution accumulation and distribution records and history for said designated charities.
